(19) United States
(12) Patent Application Publication
(10) Pub. No.: US 2023/0318113 A1
(43) Pub. Date: Oct. 5, 2023

(54) BATTERY PACK

(71) Applicant: HONDA MOTOR CO., LTD., Tokyo (JP)

(72) Inventor: Shigeru Koyama, Wako-shi (JP)

(21) Appl. No.: 18/125,768

(22) Filed: Mar. 24, 2023

(30) Foreign Application Priority Data
Mar. 31, 2022 (JP) 2022-059149

(51) Int. Cl. H01M 50/264; H01M 50/211; H01M 50/178; H01M 50/129; H01M 10/6568; H01M 10/613

(52) U.S. Cl. CPC H01M 50/264; H01M 50/211; H01M 50/178; H01M 50/129; H01M 10/6568; H01M 10/613

(57) ABSTRACT

Disclosed is a battery pack in which a plurality of laminate cells, in each of which an electrode body is housed inside an exterior body made of a laminate film and tab leads protrude from one side and the other side of the exterior body, are stacked, wherein a plurality of the tab leads protruding from the one sides and the other sides of the exterior bodies are each arranged with a gap in a stacking direction of the laminate cells, and wherein the battery pack includes: a plurality of structural bodies disposed in the gaps between the tab leads which are arranged adjacent to each other; a connection member attached to the structural body for electrically connecting the tab leads located on both sides of the structural body to each other; and a pressing portion configured to press the plurality of arranged tab leads and the connection member in a stacking direction thereof.

### CROSS-REFERENCE TO RELATED APPLICATION

Priority is claimed on Japanese Patent Application No. 2022-059149, filed Mar. 31, 2022, the content of which is incorporated herein by reference.

### BACKGROUND OF THE INVENTION

### Field of the Invention

The present invention relates to a battery pack.

### Description of Related Art

In recent years, in order to ensure access to affordable, reliable, sustainable, and advanced energy for more people, research and development have been carried out on secondary batteries that contribute to energy efficiency.

Generally, in a stacked secondary battery, one battery cell is formed by stacking a plurality of cathodes, electrolytes, and anodes. Technological development of such a stacked secondary battery is underway as it is advantageous for increasing a capacity or voltage by lamination.

For example, Japanese Unexamined Patent Application, First Publication No. 2012-28023 describes a battery having a structure in which stacked battery elements are housed inside an exterior body made of a composite film of a metal and a resin and the exterior body is sealed. In this battery, upper and lower marginal portions of the composite film which protrude from the outer periphery of the exterior body are joined by heat fusion to seal the exterior body. A configuration in which a conductive member is passed through the portion joined by heat fusion and connected to a ground is adopted.

### SUMMARY OF THE INVENTION

Since a stacked secondary battery has a structure in which a plurality of battery elements are stacked, a plurality of tab leads led out from each battery element are arranged at intervals. In the structure of the related art, there is known a structure in which adjacent tab leads of the arranged tab leads are joined by welding via a bus bar. This structure has a problem in that welding points of a bus bar are many, connection is difficult, and disassembly is not easy.

Since the tab leads are disposed at intervals, this structure has many gaps around the tab leads and their lead-out portions. In a case where the overall structure of the battery is considered, the many gaps are disadvantageous for miniaturization, and there is much wasted space. Therefore, there is a problem in that this structure cannot be referred to as a structure with sufficiently high energy density as a battery.

An aspect according to the present invention is made in view of the above-mentioned circumstances, and an object of the present invention is to provide a battery pack capable of simplifying a structure of a tab lead connection portion, eliminating wasted space, reducing the size of a battery, increasing an energy density, and contributing to energy efficiency.

In order to solve the above problems and achieve the above object, the present invention has employed the following aspects.
(1) According to an aspect of the present invention, there is provided a battery pack in which a plurality of laminate cells, in each of which an electrode body is housed inside an exterior body made of a laminate film and tab leads protrude from one side and the other side of the exterior body, are stacked, wherein a plurality of the tab leads protruding from the one sides and the other sides of the exterior bodies are each arranged with a gap in a stacking direction of the laminate cells, and wherein the battery pack includes: a plurality of structural bodies disposed in the gaps between the tab leads which are arranged adjacent to each other; a connection member provided in the structural body for electrically connecting the tab leads located on both sides of the structural body to each other; and a pressing portion configured to press the plurality of arranged tab leads and the connection member in a stacking direction thereof.

Since a portion in which the tab leads and the structural bodies are stacked is pressed in the stacking direction by the pressing portion, it is possible to obtain a structure in which the tab leads and the structural bodies are densely stacked without any gap. Since the connection member is attached to each structural body, the tab leads located on both sides of the structural body can be electrically connected to each other. Since the connection member is reliably brought into contact with the tab leads by the pressing portion, a structure in which the tab leads adjacent to each other via the structural body are reliably electrically joined to each other with low resistance is obtained. Since the structural body is disposed in a gap between the tab leads and the connection member is provided in the structural body, the electrical connection between the tab leads can be achieved in a space-saving configuration, which contributes to the miniaturization of the battery.
(2) In the above aspect (1), the pressing portion may be each of end plates positioned on both sides of the arranged tab leads in an arrangement direction and pressing the plurality of tab leads and the structural bodies in the stacking direction, and the laminate cells may be modularized by the end plates.

Since a stacked structure of the plurality of tab leads and the plurality of structural bodies is sandwiched between the end plates for pressing, it is possible to obtain a structure in which the tab leads and structural bodies are densely stacked without any gaps using the end plates. Since the stacked structure is sandwiched between the end plates for pressing, it is possible to reliably connect the tab leads to each other via the connection member. The laminate cells are modularized with these end plates.
(3) In the above aspect (2), a spacer may be disposed between the structural body and the end plate.

It is possible to obtain a structure in which the tab leads and structural bodies are densely stacked without any gaps using the spacer provided between the structural body and the end plate. Since the stacked structure is pressed using the spacer, it is possible to reliably connect the tab leads to each other via the connection member.
(4) In any one of the above aspects (1) to (3), at least one of the plurality of structural bodies may be provided with an electric device.

Since the electric device is provided in the structural body, it is possible to provide the electric device electrically connected to the tab leads, and the electric device can be used by energizing the electric device from the tab leads.

For example, if the electric device is a voltage sensor, the potential of the laminate cell can be measured.
(5) In any one of the above aspects (1) to (4), the laminate film may include an inner resin film, a metal film, and an outer resin film, at least one of the plurality of structural bodies may be provided with an electric device, and the electric device may be electrically connected to the metal film.

Since the electric device that is electrically connected to the metal film of the laminate film is provided, it is possible to electrically connect the electric device and the metal film to each other. The metal film can be used as a part of a wiring for the electric device, and simplification of the wiring can be achieved.
(6) In any one of the above aspects (1) to (5), at least one of the plurality of structural bodies may be provided with a refrigerant channel.

Since the structural body provided with the refrigerant channel is provided, it is possible to cool the tab leads via the structural body. The tab leads are parts that can become hot during use of the battery, and when the tab leads can be cooled, an effect of curbing temperature rise of the battery pack is exhibited. When the temperature rise of the battery pack can be curbed, an effect of preventing the output of the battery pack from being limited by heat and realizing the original energization performance of the battery pack is exhibited.
(7) In any one of the above aspects (1) to (5), the plurality of structural bodies may include a first electric device and a second electric device, and a structural body disposed between the structural body including the first electric device and the structural body including the second electric device may be formed of a resin and may have a refrigerant channel.

The tab lead is a portion that easily generates heat, and when the first electric device and the second electric device are provided in the structural bodies adjacent to the tab leads, heat from the first electric device and the second electric device is also added. Therefore, when the structural body between the first electric device and the second electric device can be cooled with a refrigerant, heat-generating parts including the tab leads, their surroundings, the first electric device, and the second electric device can be efficiently cooled.
(8) In the above aspect (7), the connection member provided in the structural body having the refrigerant channel may function as a cooling member for the first electric device and the second electric device disposed on both sides of the structural body.

The connection member provided in the structural body having the refrigerant channel electrically connects the tab leads on both sides thereof to each other and functions as a cooling member for cooling these tab leads. The connection member also cools the first electric device and the second electric device provided on both sides of the structural body having the refrigerant channel.

According to the aspects of the present invention, since a portion in which the tab leads and the structural bodies are stacked is pressed in the stacking direction by the pressing portion, it is possible to provide a battery pack in which the tab leads and the structural bodies are densely stacked without any gap. Since the connection member is attached to each structural body, the tab leads located on both sides of the structural body can be electrically connected to each other. Since the connection member is reliably brought into contact with the tab leads by the pressing portion, it is possible to provide a battery pack in which the tab leads adjacent to each other via the structural body are reliably electrically joined to each other.

### BRIEF DESCRIPTION OF THE DRAWINGS

FIG. 1 is a configuration diagram showing a stacked portion of tab leads on one side in a battery pack according to a first embodiment.

FIG. 2 is a configuration diagram showing a stacked portion of tab leads on the other side in the battery pack according to the first embodiment.

FIG. 3 shows parts applied to the above battery pack, FIG. 3A is a configuration diagram of a structural body having a refrigerant channel, FIG. 3B is a configuration diagram showing a structural body having a voltage sensor, FIG. 3C is a configuration diagram showing one spacer, and FIG. 3D is a configuration diagram showing the other spacer.

FIG. 4 is a configuration diagram showing a stacked portion of tab leads on one side in a battery pack according to a second embodiment.

FIG. 5 is a configuration diagram showing a stacked portion of tab leads on the other side in the battery pack according to the second embodiment.

FIG. 6 is a configuration diagram showing a stacked portion of tab leads on one side in a battery pack according to a third embodiment.

FIG. 7 is a configuration diagram showing an example of a battery pack of the related art.

FIG. 8 shows parts applied to the battery pack shown in FIG. 7, FIG. 8A is a configuration diagram of a laminate cell, FIG. 8B is a configuration diagram of a bus bar, and FIG. 8C is a configuration diagram of a voltage sensor.

FIG. 9 is a plan view of a laminate cell applied to a battery pack of a fourth embodiment.

FIG. 10 is a configuration diagram showing a circuit applied to the laminate cell having a structure of the related art.

FIG. 11 is a configuration diagram showing a circuit applied to the laminate cell applied to the battery pack of the fourth embodiment.

### DETAILED DESCRIPTION OF THE INVENTION

Hereinafter, embodiments of the present invention will be described in detail on the basis of the accompanying drawings. In the drawings used in the following description, to make characteristics easy to understand, characteristic portions may be enlarged for convenience in some cases.

A battery pack A according to a first embodiment is a battery pack in which a plurality of laminate cells 5, in each of which a plurality of electrode bodies 1 are housed inside an exterior body 2 made of a laminate film and tab leads protrude from one side and the other side of the exterior body 2, are stacked in a thickness direction.

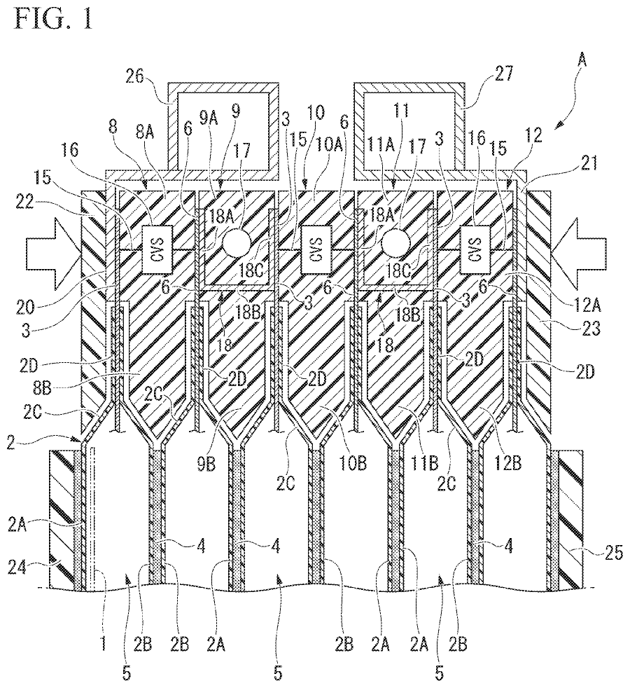

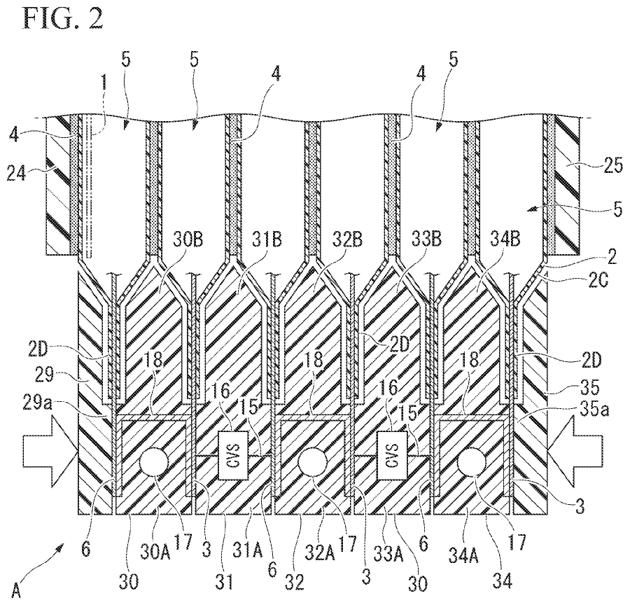

FIG. 1 shows a schematic cross-sectional structure of a stacked portion on a side on which the tab leads on one side of the stacked battery pack A protrude, and FIG. 2 shows a schematic cross-sectional structure of a stacked portion on a side on which the tab leads on the other side of the battery pack A protrude.

As the electrode body 1, a structure in which a positive electrode body and a negative electrode body are stacked via an electrolytic layer, or a structure in which a plurality of positive electrode bodies and negative electrode bodies are stacked via a separator or the like and an electrolytic solution is contained therein is applied. The positive electrode body and the negative electrode body are provided with current collector layers (not shown), and tab leads 3 on a positive electrode side or tab leads 6 on a negative electrode side connected to these current collector layers protrude outside the exterior body.

In the configuration shown in FIGS. 1 and 2, six laminate cells 5 are stacked via cushioning materials 4 such that the tab leads 3 on the negative electrode side and the tab leads 6 on the positive electrode side are alternately disposed in a stacking direction (a left-right direction in FIG. 1). Therefore, the tab leads 3 and the tab leads 6 are alternately arranged in the stacking direction of the laminate cells 5 with a gap corresponding to a thickness of the laminate cell 5 and a thickness of the cushioning material 4.

As an example, the exterior body 2 is made of a laminate film having a multilayer structure in which an inner resin film, a metal film, and an outer resin film are stacked.

As an example, the electrode body 1 has a strip shape in a plan view. In this case, the exterior body 2 is a strip-shaped body in a plan view, and the tab lead 3 protrudes by a predetermined length from one end of the exterior body 2 in a longitudinal direction, and the tab lead 6 protrudes by a predetermined length from the other end thereof.

The exterior body 2 has a structure in which a plurality of electrode bodies 1 are stacked inside and has a certain thickness, but a thickness of a portion of the exterior body 2 from which the tab lead 3 or 6 is lead out is thinner than the entire thickness of the exterior body 2. The end portions of the laminate films constituting the front and back surfaces of the exterior body 2 at the protruding portions of the tab lead 3 are brought into close contact with each other such that the tab lead 3 is sandwiched between both sides thereof in the thickness direction and are integrated by a method such as welding.

The base end portion side of the tab lead 3 is covered to be sandwiched between the end portions of the laminate films integrated by welding, but the tip end portion side of the tab lead 3 protrudes outward from the end portions of the laminate films. Although not shown in FIG. 1, the base end portion side of the tab lead 3 is connected to the current collector layer provided in the electrode body 1 inside the exterior body 2.

A structure of a portion where the tab lead 6 is sandwiched and welded between the end portions of the laminate films is the same as that of the welded portion of the tab lead 3.

In FIG. 1, the stacked portion of a plurality of the arranged tab leads 3 and 6 and their surroundings are mainly drawn, and thus the illustration of the internal structure of the laminate cell 5 is omitted. In FIG. 1, a portion where the laminate films constituting the front and back surfaces of the exterior body 2 are brought closer to each other and cover the front and back surfaces of the tab lead 3 or 6 is schematically illustrated.

The exterior body 2 includes a front surface portion 2A and a back surface portion 2B covering the front and back surfaces of the electrode body 1, an inclined portion 2C where these end portions are brought closer to the tab lead 3 or the tab lead 6, and a covering portion 2D corresponding to a portion covering both sides of the tab lead 3 or both sides of the tab lead 6.

The exterior body 2 is sealed by welding these covering portions 2D of the laminate film and their surroundings to each other.

FIG. 1 illustrates a structure in which six laminate cells 5 are stacked in their thickness direction (a left-right direction in FIG. 1). In FIG. 1, the tab leads 3 on the negative electrode side and the tab leads 6 on the positive electrode side are alternately disposed in order from the left side.

In order from the left side in FIG. 1, a first structural body 8 is interposed between a first tab lead 3 and a second tab lead 6, and a second structural body 9 is interposed between the second tab lead 6 and a third tab lead 3. A third structural body 10 is interposed between the third tab lead 3 and a fourth tab lead 6, and a fourth structural body 11 is interposed between the fourth tab lead 6 and a fifth tab lead 3. A fifth structural body 12 is interposed between the fifth tab lead 3 and a sixth tab lead 6.

The first structural body 8 is made of an insulating resin and includes a block-shaped base portion 8A sandwiched between the first tab lead 3 and the second tab lead 6 and a block-shaped extension portion 6B extending toward the inclined portion 2C of the laminate cell 5 from the base portion 8A. Since the covering portions 2D of the laminate film between which the tab lead 3 or 6 is sandwiched has a certain length in a direction perpendicular to a paper plane of FIG. 1, the base portion 8A and the extension portion 8B also have a certain length in the direction perpendicular to the paper plane of FIG. 1. The extension portion 8B is formed in a shape that occupies a space from the vicinity of a tip end portion of the covering portion 2D of the laminate film to the vicinity of the inclined portion 2C of the laminate film.

In the first structural body 8, a connection member (a connecting wiring) 15 is incorporated to pass through the base portion 8A in a thickness direction thereof, and a voltage sensor (an electric device) 16 connected to the connection member 15 is incorporated inside the base portion 8A. Both end portions of the connection member are exposed on both left and right end surfaces of the base portion 8A in FIG. 1 and are electrically connected to the tab leads 3 and 6 disposed on both left and right sides of the base portion 8A by electrode portions (not shown) provided on the exposed portions.

The third structural body 10 and the fifth structural body 12 have the same structure as the first structural body 8 and each incorporate the connection member 15 and the voltage sensor 16. The connection member 15 incorporated in the third structural body 10 is electrically connected to the tab leads 3 and 6 disposed on the left and right sides of the third structural body 10. The connection member 15 incorporated in the fifth structural body 12 is electrically connected to the tab leads 3 and 6 disposed on the left and right sides of the fifth structural body 12.

The second structural body 9 has a base portion 9A and an extension portion 9B made of an insulating resin and having substantially the same shape as the base portion 8A and the extension portion 8B provided in the first structural body 8. In the second structural body 9, a refrigerant channel 17 penetrating the central portion of the base portion 9A in a direction perpendicular to the paper plane of FIG. 1 is formed in the base portion 9A.

A refrigerant circulation pipe (not shown) or the like is connected to the refrigerant channel 17. The second structural body 9 and its surroundings can be cooled by causing a liquid refrigerant such as water to flow from the refrigerant circulation pipe to the refrigerant channel.

A connection member 18 having a U shape in a cross section shown in FIG. 1 is incorporated in the base portion 9A of the second structural body 9. The connection member 18 includes an electrode portion 18A exposed on the surface of the base portion 9A on a side close to the first structural body 8, a conductive portion 18B penetrating the base portion 9A in the thickness direction, and an electrode portion 18C exposed on the surface of the base portion 9A on a side close to the third structural body 10.

The connection member 18 incorporated in the second structural body 9 is electrically connected to the tab leads 3 and 6 disposed on both sides of the second structural body 9 in the thickness direction.

The fourth structural body 11 has the same structure as the second structural body 9. The fourth structural body 11 has a base portion 11A and an extension portion 11B, a refrigerant channel 17 is formed in the base portion 11A, and a connection member 18 is incorporated in the fourth structural body 11. The connection member 18 is electrically connected to the tab leads 3 and 6 disposed on both sides of the fourth structural body 11 in the thickness direction.

As described above, in order from the left side in FIG. 1, the tab lead 3, the first structural body 8, the tab lead 6, the second structural body 9, the tab lead 3, the third structural body 10, the tab lead 6, the fourth structural body 11, the tab lead 3, the fifth structural body 12, and the tab lead 6 are disposed.

In the stacked structure shown in FIG. 1, a negative electrode plate 20 is disposed on an outer side of the leftmost tab lead 3 in the stacking direction, and a positive electrode plate 21 is disposed on an outer side of the rightmost tab lead 6 in the stacking direction. A spacer 22 and a spacer 23 are disposed on an outer side of the negative electrode plate 20 in the stacking direction and an outer side of the positive electrode plate 21 in the stacking direction, these spacers 22 and 23 are each provided with a pressing portion (not shown) for exerting a pressing force in a direction to bring them closer to each other. A negative electrode terminal 26 is formed on an outer side of the negative electrode plate 20, and a positive electrode terminal 27 is formed on an outer side of the positive electrode plate 21.

End plates 24 and 25 are disposed on outer sides of the six stacked laminate cells in the stacking direction as shown in FIG. 1. Further, a peripheral wall of a housing container for housing the battery pack A of the present embodiment is provided on outer sides of the end plates 24 and 25.

As an example of the pressing portion, an elastic member that is in contact with the peripheral wall of the housing container described above for exerting a pressing force to the spacers 22 and 23 or an insertion member that is disposed between the peripheral wall and the spacers 22 and 23 can be applied.

The spacers 22 and 23 are positioned on both sides of the tab leads 3 and 6 arranged as described above in an arrangement direction, press the plurality of tab leads 3 and 6 and the structural bodies 8 to 12 in the stacking direction thereof, and bring them into close contact with each other.

FIG. 2 shows a schematic cross-sectional structure of a side on which the tab leads on the other side of the battery pack A are stacked.

The configuration of this stacked portion is similar to the structure of the stacked portion on the one side of the battery pack A described above with reference to FIG. 1.

In the stacked portion shown in FIG. 2, in order from the left side, a spacer 29, a tab lead 6, a sixth structural body 30, a tab lead 3, a seventh structural body 31, a tab lead 6, an eighth structural body 32, a tab lead 3, a ninth structural body 33, a tab lead 6, a tenth structural body 34, a tab lead 3, and a spacer 35 are disposed.

The sixth structural body 30, the eighth structural body 32, and the tenth structural body 34 have the same structure as the second structural body 9 described above. In contrast to the structural bodies 9 and 11 shown in FIG. 1, the structural bodies 30, 32 and 34 are disposed upside down.

The sixth structural body 30 has a base portion 30A, an extension portion 30B, a refrigerant channel 17, and a connection member 18. The eighth structural body 32 has a base portion 32A, an extension portion 32B, a refrigerant channel 17, and a connection member 18. The tenth structural body 34 has a base portion 34A, an extension portion 34B, a refrigerant channel 17, and a connection member 18.

The seventh structural body 31 and the ninth structural body 33 have the same structure as the first structural body 8 described above.

The seventh structural body 31 has a base portion 31A, an extension portion 31B, a connection member 15, and a voltage sensor 16. The ninth structural body 33 has a base portion 33A, an extension portion 33B, a connection member 15, and a voltage sensor 16.

The end plates 24 and 25 are disposed on outer sides of the six stacked laminate cells 5 in the stacking direction as shown in FIG. 2. Further, a peripheral wall of a housing container for housing the battery pack A of the present embodiment is provided on outer sides of the end plates 24 and 25. The end plates 24 and 25 support the laminate cells 5 stacked via the cushioning material 4 from both sides in the stacking direction. A plurality of laminate cells 5 are modularized with these end plates 24 and 25.

A pressing portion for executing a pressing force in a direction to bring them closer to each other is provided on each of outer sides of the spacers 29 and 35. A protrusion 29a that can be pressed against the tab lead 6 is formed on a surface of the spacer 29 on a side of the tab lead 6. The protrusion 29a allows the tab lead 6 to be properly pressed against the connection member 18 on a side surface side of the base portion 30A without any gap. A protrusion 35a that can be pressed against the tab lead 3 is formed on a surface of the spacer 35 on a side of the tab lead 3. The protrusion 35a allows the tab lead 3 to be properly pressed against the connection member 18 on a side surface side of the base portion 34A without any gap.

As an example of the pressing portion, an elastic member that is in contact with the peripheral wall of the housing container described above for exerting a pressing force to each of the spacers 29 and 35, an insertion member, or the like can be applied.

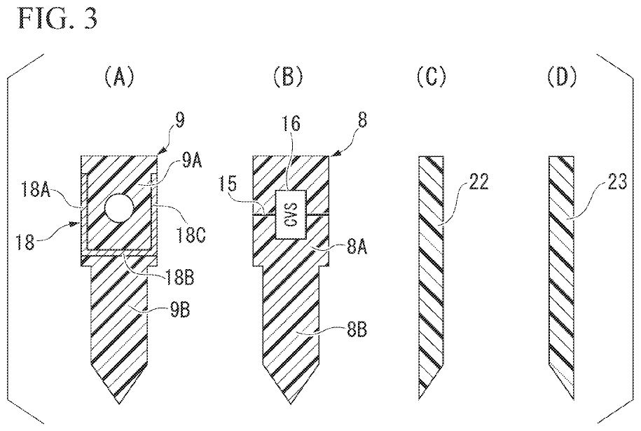

In FIG. 3, the first structural body 8, the second structural body 9, and the spacers 22 and 23 are separated from the battery pack A.

In the case of the battery pack A having the structure shown in FIGS. 1 to 3, the portion in which the tab leads 3 and 6 and the structural bodies 8 to 12 are stacked is pressed in the stacking direction by the pressing portion, and thus it is possible to obtain a structure in which the plurality of tab leads 3 and 6 and structural bodies 8 to 10 are densely stacked without any gap.

Furthermore, since the structural bodies 8, 10, 12, 31, and 33 are each provided with the connection member 15, and the structural bodies 9, 11, 30, 32, and 34 are each provided with the connection member 18, it is possible to adopt a series structure in which the tab leads 3 on the negative electrode side and the tab leads 6 of the positive electrode side of the six stacked laminate cells 5 are sequentially connected to each other, and it is possible to form the battery pack A including the negative electrode terminal 26 and the positive electrode terminal 27.

Since the connection members 15 and 18 and the tab leads 3 and 6, and furthermore the negative electrode plate 20 and the positive electrode plate 21, are reliably brought into contact with each other at the contact points thereof by the pressing portion, the battery pack A having a structure in which the tab leads 3 and 6 adjacent to each other via the above-described structural body are reliably electrically joined to each other is obtained. A low-resistance connection can be achieved at each contact point by joining the tab leads 3 and 6 to each other with the pressing portion.

In the battery pack A, by providing the structural bodies 9, 11, 30, 32, and 34 each having the refrigerant channel 17, it is possible to cool the tab leads 3 and 6 via the structural bodies 9, 11, 30, 32, and 34. The tab leads 3 and 6 are parts that can become hot during use of the battery pack, and when the tab leads 3 and 6 can be cooled, an effect of curbing temperature rise of the battery pack A is exhibited.

When the temperature rise of the battery pack A is curbed, an effect of curbing output limitation due to the heat of the battery pack A is exhibited. Therefore, the original battery performance of the battery pack A can be fully exhibited.

In the configuration shown in FIG. 1, the voltage sensors 16 are disposed on both sides of the second structural body 9 in the stacking direction as an electric device. For this reason, it is possible to efficiently cool the two voltage sensors 16 and their surroundings by utilizing the refrigerant channel 17 disposed near the voltage sensors 16 and 16 which can become heat sources.

Since the voltage sensors 16 are disposed on both sides of one refrigerant channel 17, one voltage sensor 16 can be referred to as a first electric device, and the other voltage sensor 17 can be referred to as a second electric device. The refrigerant channel 17 sandwiched between these two electric devices (the voltage sensors 16 and 16) functions as a cooling member for the two electric devices.

Since a plurality of voltage sensors 16 are incorporated in the battery pack A, in a case where any of the laminate cells 5 malfunctions and causes an abnormality such as a voltage drop, the abnormality such as a voltage drop in the laminate cell 5 can be reliably detected.

In the structure of the related art, a space between the tab leads 3 and 6 was not particularly used and was an empty space. On the other hand, in the battery pack A, this space is effectively used, and a plurality of structural bodies are used to provide the refrigerant channel 17 and the voltage sensor 16, and thus the configuration is such that there is little wasted space. Therefore, the battery pack A of the present embodiment has less wasted space than the battery pack of the related art and thus can be miniaturized.

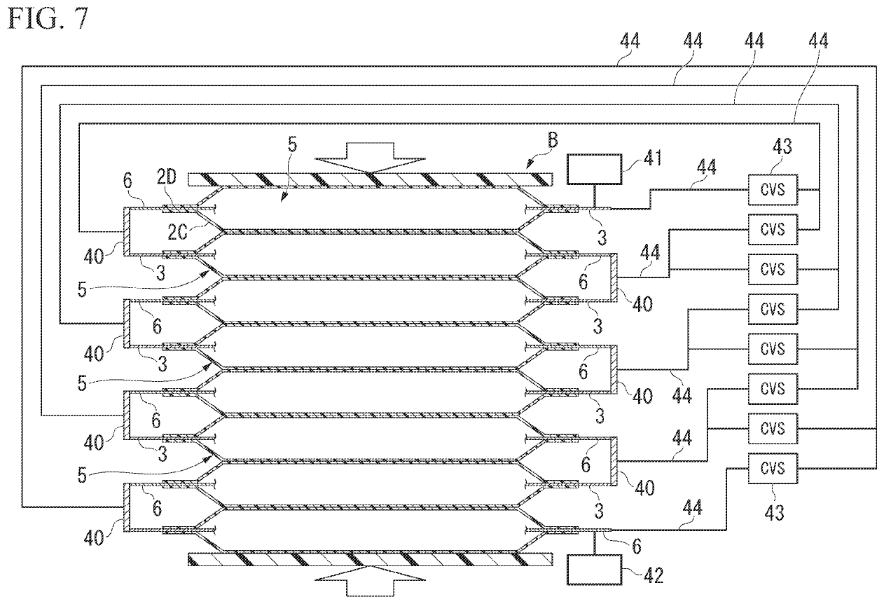

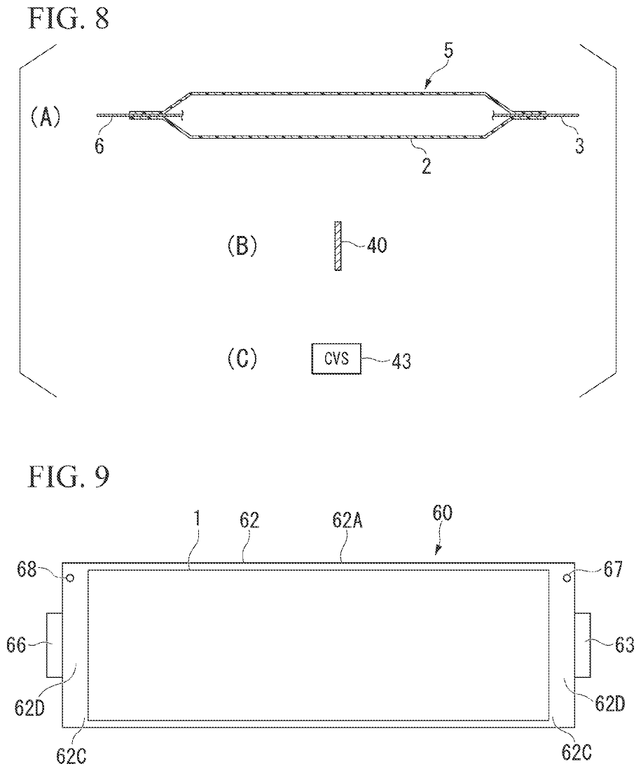

FIG. 7 is a configuration diagram showing an example of a battery pack of the related art including a voltage sensor and a bus bar.

In a battery pack B, the configuration in which the laminate cells 5 are stacked such that the tab leads 3 on the positive electrode side and the tab leads 6 on the negative electrode side are alternately disposed in the stacking direction is the same as that of the battery pack A of the first embodiment described above.

The configuration in which the exterior body 2 is made of a laminated film is also the same, and the configuration in which the tab lead 3 on the negative electrode side protrudes by a predetermined length from one end of the exterior body 2 in the longitudinal direction and the tab lead 6 on the positive electrode side protrudes by a predetermined length from the other end thereof is also the same.

The battery pack B has a structure in which eight laminate cells 5 are stacked in the thickness direction, and the tab leads 3 and the tab leads 6 alternately arranged in the stacking direction of the laminate cells 5 are joined by a bus bar 40. Both ends of the bus bar 40 are welded to the adjacent tab leads 3 and 6.

For this reason, in the battery pack B shown in FIG. 7, three bus bars 40 are used for a right connection portion of the structure in which the eight laminate cells 5 are stacked, and four bus bars 40 are used for a left connection portion of the structure in which the eight laminate cells 5 are stacked. Therefore, assuming that a total of seven bus bars 40 are used and both ends thereof are welded, the structure requires welding at 14 points.

If a negative electrode terminal 41 is welded to one tab lead 3 and a positive electrode terminal 42 is welded to the other tab lead 6, welding at two points is further required. Therefore, in the battery pack B having the structure of the related art, there are many welding points, and the manufacturing itself of the battery pack B is extremely difficult.

Furthermore, in a case where eight voltage sensors 43 are provided in the battery pack B, the voltage sensor 43 is connected to the tab leads 3 and 6 positioned at both ends of one laminate cell 5 via a harness wiring 44. For this reason, it is necessary to provide at least eight sets of the harness wiring 44 in the battery pack B, which causes a problem of a complicated wiring.

On the other hand, in the battery pack A described with reference to FIGS. 1 to 3, the bus bar 40 is not required, welding is not required, and a wiring to the voltage sensor can be greatly simplified.

Moreover, in the battery pack B, the space between the tab leads 3 and the tab leads 6 is an unused space, and the voltage sensor 43 and the harness wiring 44 have to be disposed outside the laminate cell 5, resulting in a large and complicated battery structure. On the other hand, in the battery pack A, the connection members 15 and 18 and the voltage sensor 16 are disposed using the space between the tab leads 3 and 6, and thus the structure can be simplified and wasted space is eliminated to reduce the overall size.

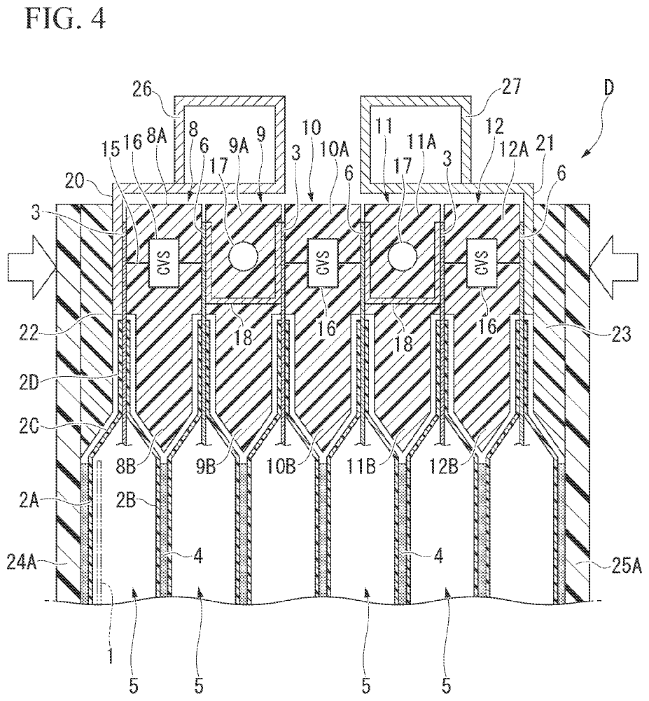

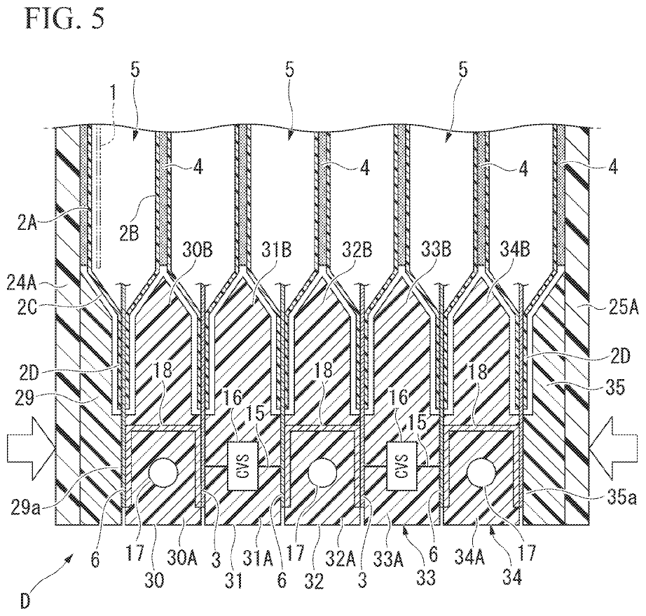

FIGS. 4 and 5 are schematic cross-sectional views showing a battery pack D according to a second embodiment of the present invention.

In the battery pack D, the structure in which six laminate cells 5 are stacked in the thickness direction thereof is the same as the structure of the first embodiment described above.

In the battery pack D shown in FIGS. 4 and 5, the structure in which a spacer 22, a negative electrode plate 20, a tab lead 3, a first structural body 8, a tab lead 6, a second structural body 9, a tab lead 3, a third structural body 10, a tab lead 6, a fourth structural body 11, a tab lead 3, a fifth structural body 12, a tab lead 6, a positive electrode plate 21, and a spacer 23 are disposed in order from the left side is also the same.

The structure of the second embodiment differs from the structure of the first embodiment in that an end plate 24A extends to an outer side of the spacer 22 and an end plate 25A extends to an outer side of the spacer 23.

The second embodiment is characterized in that the end plate 24A is positioned on an outer side of the spacer 22, the end plate 25A is positioned on an outer side of the spacer 23 and the end plates 24A and 25A are configured as the pressing portion for each pressing the spacer 22 and the spacer 23.

The end plates 24A and 25A press the plurality of tab leads and the plurality of structural bodies interposed between the spacers 22 and 23 to bring them into close contact with each other and improve the electrical connectivity of each contact point.

As shown in the second embodiment, each of the end plates 24A and 25A may be used as the pressing portion.

In addition, in the battery pack B of the second embodiment, the same effects as those of the battery pack A of the first embodiment can be obtained.

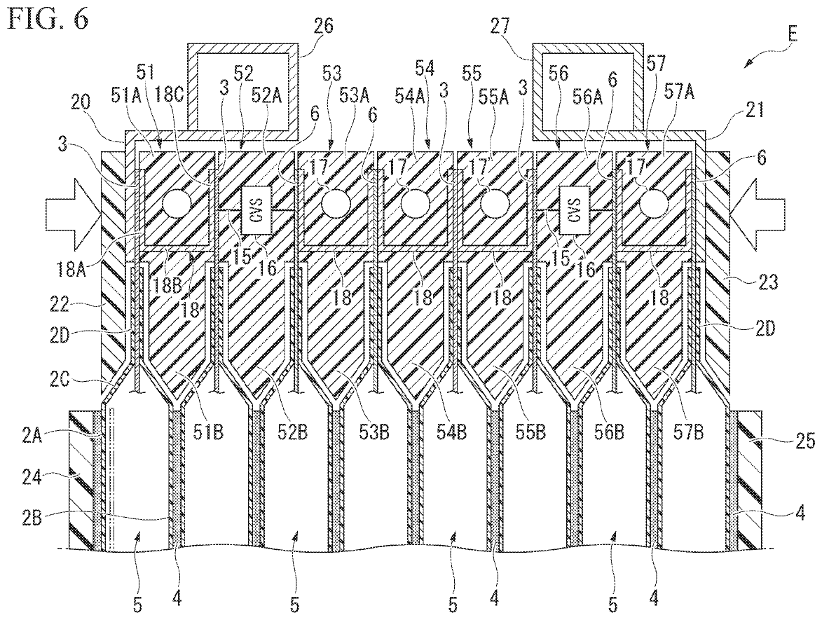

FIG. 6 is a schematic cross-sectional view showing a battery pack E according to a third embodiment of the present invention.

FIG. 6 shows a schematic cross section of the battery pack E corresponding to the cross-sectional schematic structure of the stacked portion on a side on which the tab leads on one side of the battery pack A shown in FIG. 1 protrude.

In the battery pack E, the laminate cell 5 having the tab lead 3 or 6 has the same structure as the above laminate cell, but eight laminate cells 5 are stacked in the thickness direction via the cushioning material 4.

In the structure of FIG. 6, in order from the left side, a spacer 22, a negative electrode plate 20, a tab lead 3, a first structural body 51, a tab lead 3, a second structural body 52, a tab lead 6, a third structural body 53, a tab lead 6, a fourth structural body 54, a tab lead 3, a fifth structural body 55, a tab lead 3, a sixth structural body 56, a tab lead 6, a seventh structural body 57, a tab lead 6, a positive electrode plate 21, and a spacer 23 are disposed.

The first structural body 51, the third structural body 53, the fourth structural body 54, the fifth structural body 55, and the seventh structural body 57 have the same structure as the second structural body 9 of the first embodiment.

The second structural body 52 and the sixth structural body 56 have the same structure as the first structural body 8 of the first embodiment.

The first structural body 51 has a base portion 51A, an extension portion 51B, a refrigerant channel 17, and a connection member 18. The third structural body 53 has a base portion 53A, an extension portion 53B, a refrigerant channel 17, and a connection member 18. The fourth structural body 54 has a base portion 54A, an extension portion 54B, a refrigerant channel 17, and a connection member 18. The fifth structural body 55 has a base portion 55A, an extension portion 55B, a refrigerant channel 17, and a connection member 18. The seventh structural body 57 has a base portion 57A, an extension portion 57B, a refrigerant channel 17, and a connection member 18.

The second structural body 52 has a base portion 52A, an extension portion 52B, a connection member 15, and a voltage sensor 16. The sixth structural body 56 has a base portion 56A, an extension portion 56B, a connection member 15, and a voltage sensor 16.

In the battery pack E of FIG. 6, the connection member 18 of the first structural body 51 connects the tab leads 3 and 3 on the negative electrode side of the laminate cells 5 and 5 located on both sides thereof to each other.

The connection member 15 of the second structural body 52 connects the tab leads 3 and 6 of the laminate cells 5 and 5 located on both sides thereof to each other.

The connection member 18 of the third structural body 53 connects the tab leads 6 and 6 on the positive electrode side of the laminate cells 5 and 5 located on both sides thereof to each other.

The connection member 15 of the fourth structural body 54 connects the tab leads 3 and 6 of the laminate cells 5 and 5 located on both sides thereof to each other.

The connection member 18 of the fifth structural body 55 connects the tab leads 3 and 3 on the negative electrode side of the laminate cells 5 and 5 located on both sides thereof to each other.

The connection member 15 of the sixth structural body 56 connects the tab leads 3 and 6 of the laminate cells 5 and 5 located on both sides thereof to each other.

The connection member 18 of the seventh structural body 57 connects the tab leads 6 and 6 on the negative electrode side of the laminate cells 5 and 5 located on both sides thereof to each other.

In the battery pack E shown in FIG. 6, the description of the configuration of the tab leads on the opposite side and the structural body provided between the tab leads, which are not shown, will be omitted.

The battery pack E configured as described above is a battery in which the tab leads 3 and 3 or the tab leads 6 and 6 on the same electrode side of two laminate cells 5 adjacent in the stacking direction are connected to each other to form a parallel structure. Since this battery pack E has the adjacent laminate cells 5 and 5 connected in parallel, it has a feature that the output voltage is lower than that of the battery pack A described above, but the capacity can be increased.

Other configurations are the same as those of the battery pack A of the first embodiment, and the effects of the battery pack A of the first embodiment can be similarly obtained.

As clarified in the structure shown in FIG. 6, it is possible to correspond to the battery pack E having the parallel structure shown in FIG. 6 by simply changing the stacking direction of the laminate cells 5, using the same structural body as the battery pack A having the series structure of the first embodiment is, and changing a installation position in a case where the laminate cells 5 are stacked.

The number of stacked layers of the laminate cells 5 in the battery pack can be arbitrarily selected, and the structural body described above can be applied to either a series connection structure or a parallel connection structure according to the number of stacked layers. Either the structural body provided with the voltage sensor 16 or the structural body provided with the refrigerant channel 17 may be applied to the structural body provided between the tab leads. If necessary, the structural body provided with the voltage sensor 16 may be applied to all the structural bodies, or the structural body provided with the refrigerant channel 17 may be applied to all the structural bodies. The number of applications of either structural body can also be selected arbitrarily.

FIG. 9 is an explanatory diagram showing the laminate cell applied to the battery pack according to the fourth embodiment of the present invention.

A laminate cell 60 shown in FIG. 9 has the same configuration as the laminate cell 5 of the first embodiment described above in terms of a configuration in which the electrode body 1 inside is covered with an exterior body 62.

The exterior body 62 includes a front surface portion 62A and a back surface portion (not shown), an inclined portion 62C where these end portions are brought closer to a tab lead 63 on the negative electrode side or a tab lead 66 on the positive electrode side, and a covering portion 62D corresponding to a portion covering both sides of the tab lead 3 or both sides of the tab lead 6.

The laminate cell 60 of the third embodiment is the same as the laminate cell 5 of the first embodiment in that the exterior body 62 is sealed by welding these covering portions 62D of the laminate film and their surroundings.

A characteristic configuration of the laminate cell 60 is that holes 67 and 68 for connecting one end of a wiring to a metal film 62E in the laminate film constituting the exterior body 62 are formed in a part of the exterior body 62. One hole 67 is formed at a position where it opens to the metal film in the laminate film at a position close to the tab lead 63 on the negative electrode side, and the other hole 68 is formed at a position where it opens to the metal film in the laminate film at a position close to the tab lead 66 on the positive electrode side.

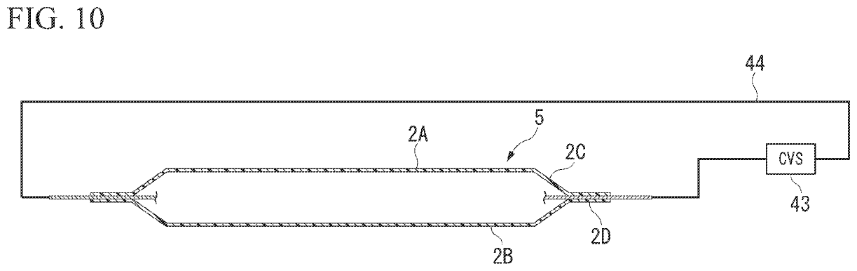

FIG. 10 is a schematic diagram showing a circuit in which the voltage sensor 43 is connected to one laminate cell 5 via the harness wiring 44 in the battery pack B of the related art shown in FIG. 7.

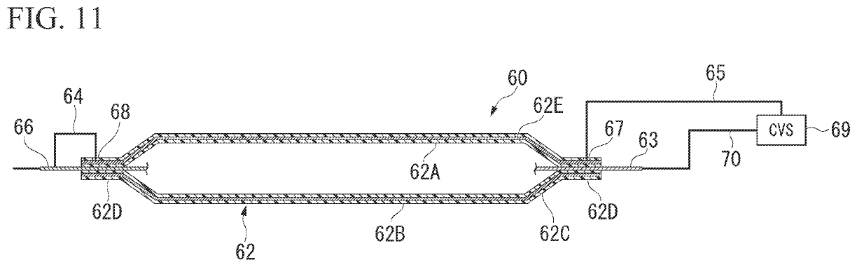

On the other hand, as shown in FIG. 9, in the configuration in which the holes 67 and 68 are provided in the exterior body 62, one end of a wiring 65 is connected to the metal film 62E in the laminate film via the hole 67 as shown in FIG. 11, and the other end of the wiring 65 is connected to one connection terminal of a voltage sensor 69. One end of a wiring 64 is connected to the metal film 62E in the laminate film via the hole 68, and the other end of the wiring 64 is connected to the tab lead 66 on the positive electrode side. The other connection terminal of the voltage sensor 69 is connected to the other tab lead 63 of the laminate cell 5 through a wiring 70.

In FIG. 11, the voltage sensor 69 is drawn at a position away from the tab lead 63 such that the wiring can be easily seen, but the position where the voltage sensor 69 is provided is inside the structural body shown in FIG. 1 and the like.

By adopting the configuration shown in FIG. 11, most of the harness wiring 44 required in the structure of the related art shown in FIG. 10 can be substituted with the metal film 62E, and the harness wiring 44 can be simplified.

In the configuration shown in FIG. 11, the metal film 62E in the laminate film can be used as a part of the harness wiring to operate the voltage sensor 65, thereby simplifying the harness wiring in a case where the battery pack is formed.

What is claimed is:

1. A battery pack in which a plurality of laminate cells, in each of which an electrode body is housed inside an exterior body made of a laminate film and tab leads protrude from one side and the other side of the exterior body, are stacked,
wherein a plurality of the tab leads protruding from the one sides and the other sides of the exterior bodies are each arranged with a gap in a stacking direction of the laminate cells, and
wherein the battery pack comprises:
a plurality of structural bodies disposed in the gaps between the tab leads which are arranged adjacent to each other;
a connection member provided in the structural body for electrically connecting the tab leads located on both sides of the structural body to each other; and
a pressing portion configured to press the plurality of arranged tab leads and the connection member in a stacking direction thereof.

2. The battery pack according to claim 1, wherein the pressing portion is each of end plates positioned on both sides of the arranged tab leads in an arrangement direction and pressing the plurality of tab leads and the structural bodies in the stacking direction, and the laminate cells are modularized by the end plates.

3. The battery pack according to claim 2, wherein a spacer is disposed between the structural body and the end plate.

4. The battery pack according to claim 1, wherein at least one of the plurality of structural bodies is provided with an electric device.

5. The battery pack according to claim 1, wherein the laminate film includes an inner resin film, a metal film, and an outer resin film, at least one of the plurality of structural bodies is provided with an electric device, and the electric device is electrically connected to the metal film.

6. The battery pack according to claim 1, wherein at least one of the plurality of structural bodies is provided with a refrigerant channel.

7. The battery pack according to claim 1, wherein the plurality of structural bodies include a first electric device and a second electric device, and a structural body disposed between the structural body including the first electric device and the structural body including the second electric device is formed of a resin and has a refrigerant channel.

8. The battery pack according to claim 7, wherein the connection member provided in the structural body having the refrigerant channel functions as a cooling member for the first electric device and the second electric device disposed on both sides of the structural body.
